(19) United States
(12) Patent Application Publication
(10) Pub. No.: US 2018/0038347 A1
(43) Pub. Date: Feb. 8, 2018

(54) Method to use wind power to create electrical energy in buildings from electrolysis and steam

(71) Applicant: Carlos Gabriel Oroza, Dallas, TX (US)

(72) Inventor: Carlos Gabriel Oroza, Dallas, TX (US)

(21) Appl. No.: 15/731,569

(22) Filed: Jun. 30, 2017

Related U.S. Application Data
(60) Provisional application No. 62/411,305, filed on Oct. 21, 2016.

(51) Int. Cl. F03D 9/25; F03D 1/02; F01K 7/16; C25B 1/04; F01K 23/10; F01K 13/00; H02K 7/18; F03D 9/00

(52) U.S. Cl. CPC F03D 9/25; H02K 7/183; F03D 1/02; F03D 9/007; C25B 1/04; F01K 23/10; F01K 13/006; F01K 7/16; F05B 2240/9112

(57) ABSTRACT

The present invention provides a method to generate self contained electrical power within a building by capturing wind energy to generate kinetic energy, yielding DC current and transferring DC current from generators through anode and cathode to an electrolyzer; using a catalyst and heat for the electrolysis of water to improve the production of hydrogen and Oxygen. Yielding Oxygen and Hydrogen from electrolyzer and compressing them for storing separately in gaseous or liquid form for further igniting Hydrogen and Oxygen in a combustion chamber to generate heat to generate high pressure steam to run steam turbines to further generate electricity for the consumption requirements of the building or a user.

This invention combines in a linear order components, the majority of which exist and are commercially available, which transform wind power into electrical power to provide electricity to a building making it possible for the building to become its own clean energy power plant, independent from the grid.

### CROSS REFERENCE TO RELATED APPLICATIONS

The present patent application is a continuation in part of provisional U.S. patent application No. 62/411,305 filed on Oct. 21, 2016, the disclosure of which herein is incorporated by reference to the extent not inconsistent with the present disclosure.

### BACKGROUND OF THE INVENTION

Energy production and reduction of pollutants is one of the greatest challenges of our generation.

Populations continue to migrate towards urban areas and COP21 identified cities as key actors in the fight against climate change. Today, 55% of the world's population lives in cities while accounting for over 70% of the global carbon emission. This global trend towards urbanization is projected to continue beyond 2050, where two thirds of the world population will live. Electricity production in the United States alone is the greatest contributor of CO2 emissions with 67% being produced by fossil fuels (mostly coal and natural gas). Renewable sources only account for 14 percent of our production.

Energy costs are soaring and in some of the poorest countries, having a few lights on at home is a luxury. In large metropolitan areas energy consumption is highly regulated and limited to a few that can afford such luxuries. Electricity is too costly and it is too dirty to produce when relying mostly on fossil fuels.

The 21^{st} Conférence des parties (COP) held in Paris in 2015 reinforced the need for global action to curtail the impact of human generated carbon emissions on the warming of our planet.

There are systems which will capture wind to convert into electricity as well as solar energy panels, or magnet generators and store such energy in batteries or the like to reduce the consumption of energy needs generally in residences. In most cases the energy produced by these systems is limited by the unreliability of wind and sun, thus homes in general continues to use partial electricity from the grid. In some cases the energy stored in the residences is in excess of the user requirements and, the user may sell the excess electricity back to the power supplier.

Unlike a house; a high-rise building requires an immense amount of electrical energy to power systems and spaces. Making a high-rise building its own power plant will remove the building from the grid and the recovery of the capital invested in the new system will far offset the cost of energy from power plants.

Making a high-rise building a power plant will also allow for high-rise building owners to produce excess amounts in order to sell energy to neighbors or buildings nearby. The method does not cause any pollution; rather it recycles water and waste.

Additionally; this method can be used in large ships such as cruise ships or even as large as aircraft carriers depending on the scale of the systems installed. Not only there are high winds in the ocean but a moving ship would add to the collection of wind power and follow the method as described.

### SUMMARY OF INVENTION

The present invention relates to a method to produce electrical energy utilizing wind power as a source, converting kinetic energy into electrical energy to generate Hydrogen and Oxygen through electrolysis and using Hydrogen and Oxygen as fuel to produce steam to power steam turbines which will ultimately generate electrical power to provide electricity to a building.

To illustrate the system method a preferred embodiment of the invention is illustrated with the inclusion of the wind turbine apparatus U.S. Pat. No. 9,546,644 B2 as the wind capturing device; however it is to be understood that the description of the preferred embodiment contains many specifics for the purpose of illustration; a person of ordinary skill in the art will appreciate that many variations and alterations to the following details are within the scope of the invention. Accordingly, the following preferred embodiments of the invention are set forth without loss of generality to, and without imposing limitations upon the claimed invention.

### DESCRIPTION OF THE FIGURES

FIG. 1 represents a variety of buildings 1, depicting samples of multi-story structures wherein an energy generating system may be installed using wind power to create electrical energy from Electrolysis and steam.

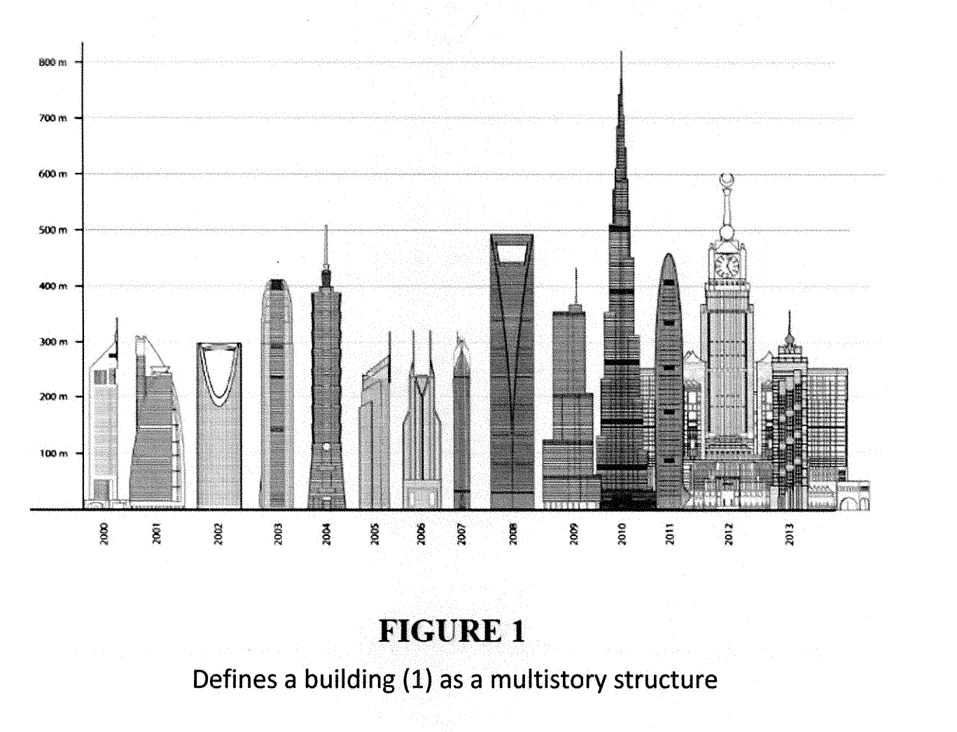

FIG. 2 is a graphic representation of the system, its components and the method for converting wind power to electrical power with the capacity to power a high-rise building and the owner's requirements of electricity within the structure.

FIGS. 3, 4 and 5 are top, lower and right side portions respectively of FIG. 2 enlarged to allow the reader a better view of the components of the method.

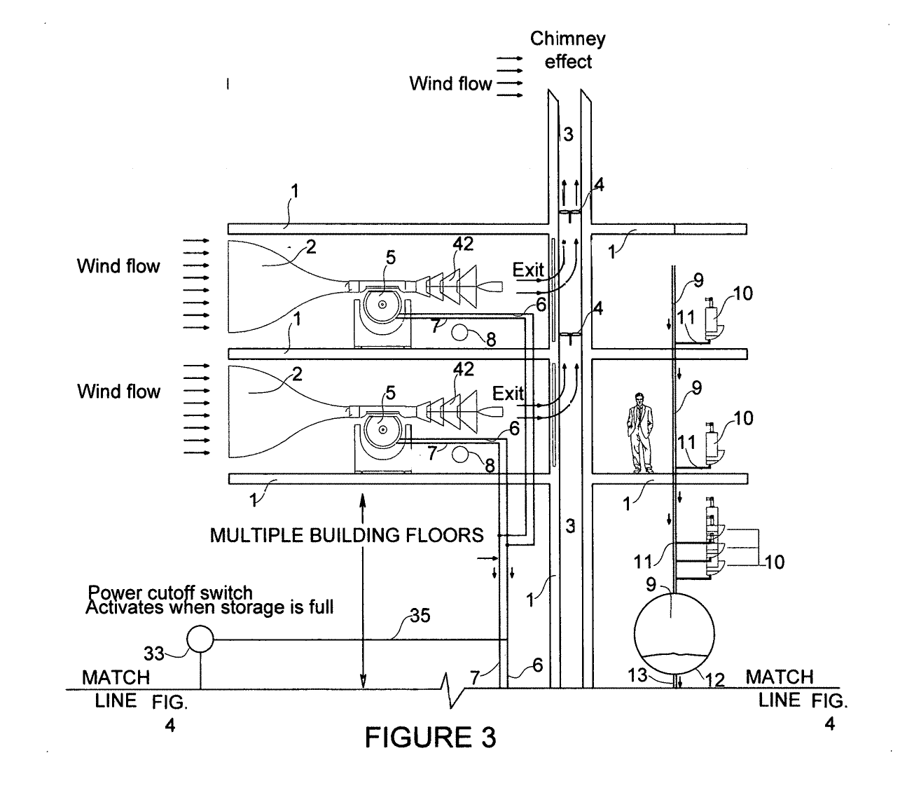

FIG. 3 is a cross section of the upper portion of FIG. 2 where in a high-rise building 1 a plurality of turbines 2 are installed in separate floor and or independent spaces within a high-rise building 1. Turbines as shown are the preferred embodiment of this invention; however other systems that may produce DC power directly or indirectly may substitute the turbines 2. Wind turbines 2 transform wind power into kinetic energy which is used to spin generators 5. Wind exiting the wind turbines is decompressed and released directly through openings in the structure at opposite side of the face of the high-rise building that faces the prevailing winds. When these openings are not easily accessible a chase 3 serves as the exit of the decompressing air. These chases 3 may end above the rooftop of the high-rise building in order to take advantage of the chimney effect which will create a vacuum in the chase increasing the speed of the wind exiting through the chase. Inside the chase fans 4 may be installed to further aid the rapid exit of the decompressed air.

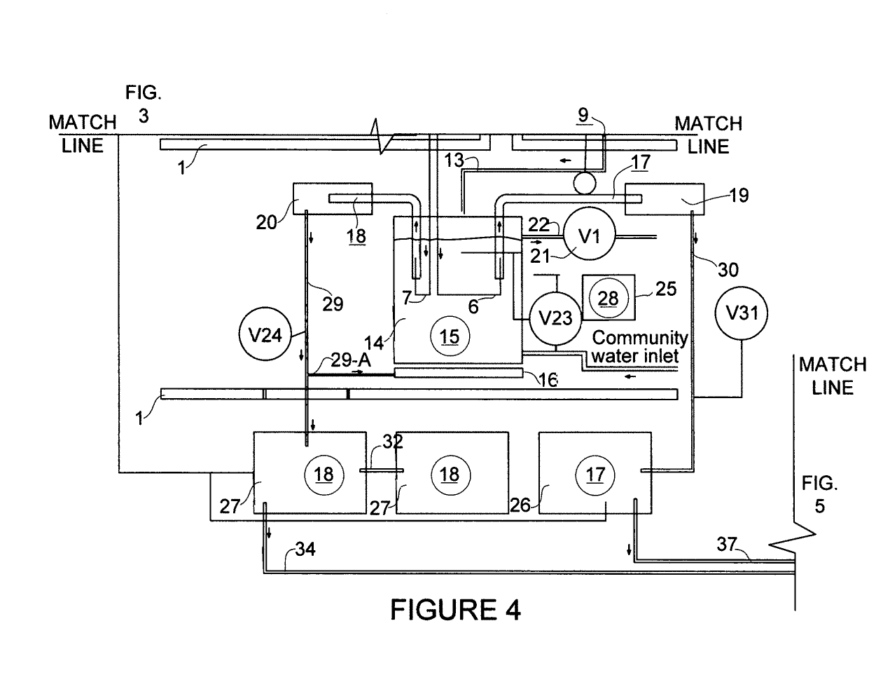

The DC output of the generators 5 is controlled and regulated by 8 equipment appropriate to maintain optimal electrical current levels for the purpose of using such DC current for electrolysis of a fluid. Cathode 7 and Anode 6 carry the electrical current from the generators 5 to the electrolyzer 14 further described in FIG. 4

FIG. 4 is a cross section of the lower portion of FIG. 2 wherein the cathode and anode comprise nickel, platinum, titanium, graphite or other metal or alloy that will best resist the corrosive nature of the environment in the electrolyzer 14 wherein the electrolyzing fluid 15 comprises H²O and a catalyst such as a salt or an acid. In this method acid is preferred as there is within the high-rise building 1 an abundant supply of Urea already mixed with water 9. Harvesting Urea from urinals 10 in an existing high-rise building will require slight modification of the plumbing system 11 to separate waste from bathroom plumbing fixtures. In new construction, plumbing systems can be designed already for the separation of waste.

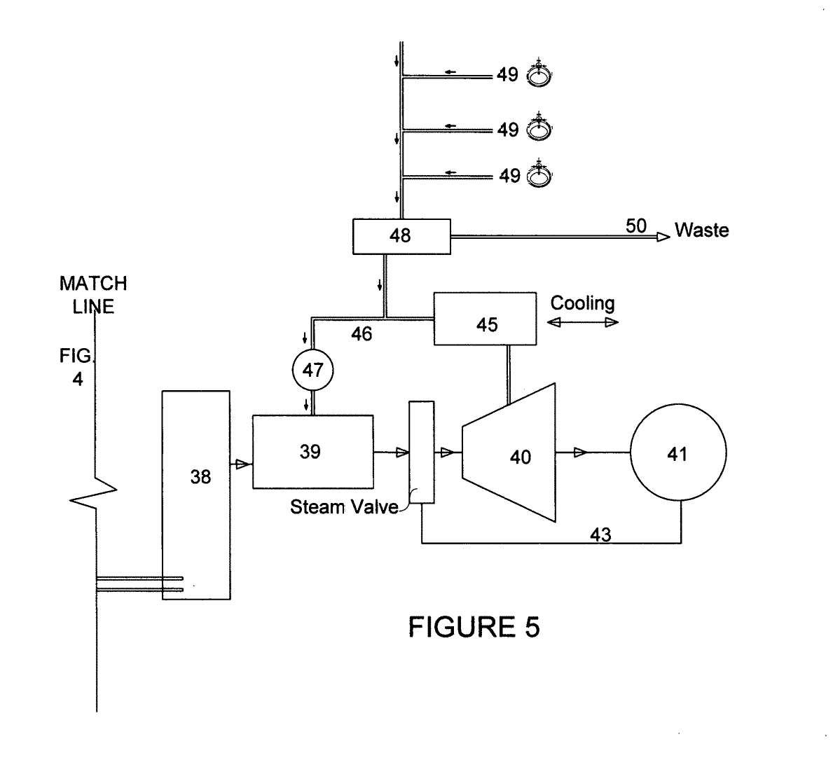

Water mixed with Urea 9 from Urinals 10 contains solids which are filtered and stored in tanks 12 for as needed demand. Water and Urea 9 after being filtered and stored are released as needed into the electrolyzer 14 through pipes 13 to maintain the level of fluid 15. Valve 21 senses the level of water and acidity in the electrolyzer and opens or closes the exit of fluid to sewer through waste pipe 22 or stops the flow of mix 9 into the electrolyzer 14. Community water may be used when the available mix 9 is in short supply. Valve 23 senses that the level of the fluid 15 has fallen below an established level and allows community water to enter the electrolyzer 14. To maintain the acidity of the fluid 15 when necessary a catalyst 28 is stored in tank 25 which supplies community water the needed level of acidity to maintain electrolysis at an optimum level of efficiency.

Cathode 7 and Anode 6 when submerged in the fluid 15 will split water into Oxygen 17 and Hydrogen 18 which are compressed by compressors 19 and 20 respectively. Compressed Hydrogen flows through pipe 29 to a plurality of tanks 27. Hydrogen from pipe 29 is partially deviated through pipe 29-A and it is ignited in burners 16 in order to raise the temperature of the fluid and further optimize the production of Oxygen 17 and Hydrogen 18. Compressed Oxygen 17 flows through pipe 30 into a plurality of storage tanks 26. Valve 31 stops compressor 19 when pressure on the plurality of tanks 26 has reached its established maximum. Similarly; valve 24 stops compressor 20 when pressure on the plurality of Hydrogen storage tanks has reached its established level. Switch 33 as a safety precaution automatically cuts of the power from cathode 7 and anode 6 when storage tanks 26 and 27 have reached their maximum established pressure and electrolysis stops. Pipe 32 connects together the plurality of tanks and releases pressure between tanks to keep the pressure of first tank at a highest level before Oxygen 17 or Hydrogen 18 flow into a second tank and so on.

Compressed Hydrogen 18 and Oxygen 17 are released from the plurality of tanks in high pressure lines 34 and 37 respectively to a combustion chamber 38 further described in FIG. 5

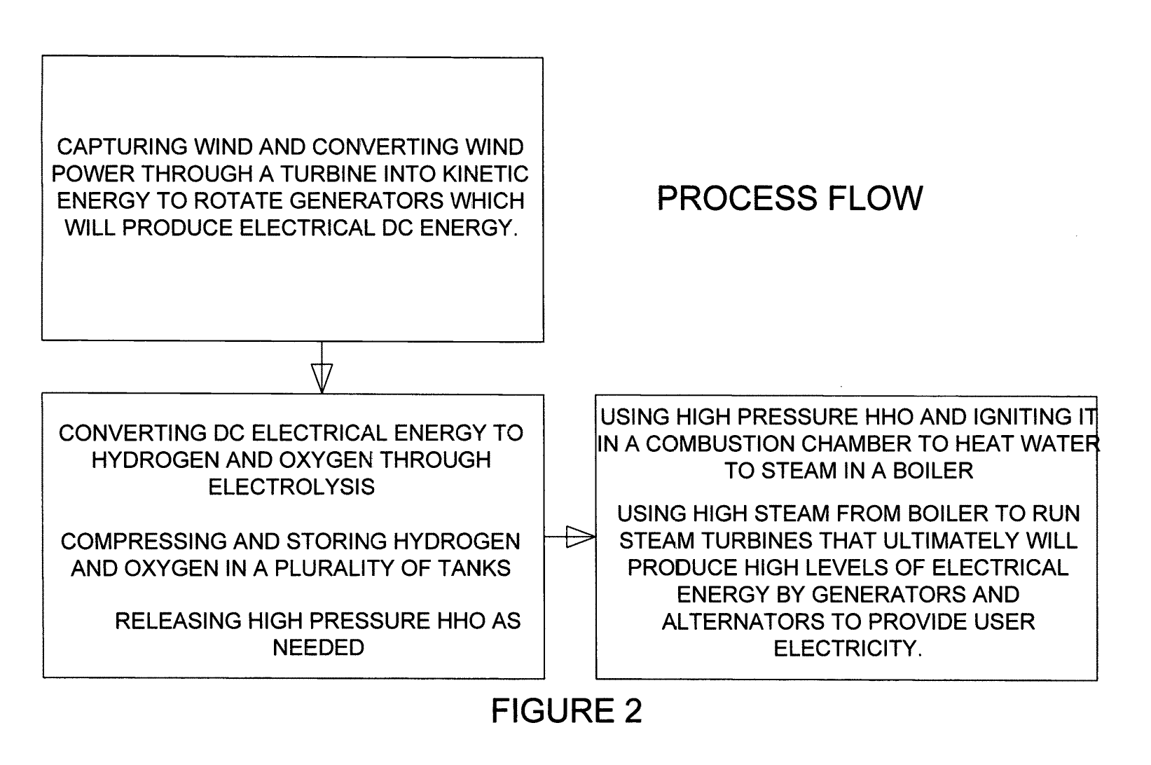

FIG. 5 is a cross section of the lower right hand portion of FIG. 2 wherein compressed Oxygen 17 and Hydrogen 18 are ignited in combustion chamber 38 to raise the temperature of water in steam boiler 39. Regulated High temperature steam at predetermined pressure passes from Steam Boiler though steam valve into steam turbine 40. Steam leaving the steam turbine 40 passes to a steam condenser 45 where it is cooled and is circulated through pipe 46 back into the steam boiler 39 by pump 47. Water on pipe 46 may be complemented by water collected from sinks 49 in high-rise building after passing through filter 48. Solids are eliminated through pipe 50. Additional water may be required at times to maintain steady the pressure within the boiler 39.

Steam turbine 40 generates kinetic power which is converted into electrical energy by generator 41 and then converted into AC current to power the high-rise building 1.

What is claimed:

1. A method of generating power within a building comprising;
capturing wind energy to generate kinetic energy through a plurality of turbines;
yielding DC electricity from kinetic energy through a plurality of generators which are coupled to the plurality of turbines;
transferring DC electricity from the plurality generators to an electrolyzer;
collecting a water and urea mix from a plurality of urinals, wherein the urinals are located within a building;
filtering the water and urea mix;
capturing the water and urea mix to form a catalyst for electrolysis of water, wherein the catalyst improves a production of hydrogen and oxygen.
electrolyzing the water and urea mix in an electrolyzer;
raising a temperature of the water and urea mix in the electrolyzer, wherein raising the temperature of the water and urea mix in the electrolyzer improves the production of hydrogen and oxygen.
yielding oxygen and hydrogen from the electrolyzer, wherein a capacity of the electrolyzer is configured based on the oxygen and hydrogen required to run a plurality of steam turbines necessary to supply an energy consumption requirement of the building or a user;
compressing the oxygen and hydrogen;
separately storing oxygen and hydrogen in a plurality of tanks in gaseous or liquid form, wherein a combined capacity of the plurality of tanks is configured based on the energy consumption requirement of the building or a user;
discharging, at a high pressure, the oxygen and hydrogen from the plurality of tanks to ignite in a combustion chamber;
capturing heat in the combustion chamber to create high pressure steam in a boiler; wherein the capacity of the boiler is configured based on a quantity, a temperature, and a pressure required by the plurality of steam turbines;
capturing the high pressure steam to run the plurality of steam turbines;
yielding DC electricity; and
converting DC electricity to AC electricity to provide electricity for the energy consumption requirement of the building or a user.

2. The method of generating power within a building of claim 1, further comprising yielding DC electricity with solar panels.

3. The method for generating power within a building of claim 1, further comprising yielding DC electricity independently of other sources with a magnet generator.

4. The method of generating power within a building of claim 1, further comprising wherein cathode and anode comprising platinum, graphite, nickel or an alloy may be used for transferring DC electricity from generators to an electrolyzer.

5. The method of generating power of claim 1, wherein collecting the water and urea mix comprises collecting the water and urea mix with existing plumbing systems of the building.

6. The method of generating power of claim 1, wherein raising the temperature of the the water and urea mix comprises a ignited hydrogen or heat from boilers within the building.

7. The method of generating power of claim 1, wherein yielding oxygen and hydrogen comprises electrolyzing a fluid.

8. The method of generating power of claim 1, further comprises storing oxygen and hydrogen in the plurality of tanks may in a gaseous or a liquid form.

9. The method of generating power of claim 1, wherein discharging the oxygen and hydrogen from the plurality of tanks to the combustion chamber comprises igniting and generating heat for raising a temperature of water in a boiler.

10. The method of generating power of claim 9, further comprises raising the temperature of water in a boiler yielding high pressure steam.

11. The method of generating power of claim 10, wherein capturing high pressure steam is used to run steam turbines

12. The method of generating power of claim 11, wherein the steam turbines yield CD electricity.

13. The method of generating power of claim 1, further comprises converting DC electricity to AC electricity with alternators and supplied to end user.

14. The method of generating power of claim 1; wherein converting wind energy to kinetic energy is achieved with turbines located in a single or multiple floors with the building and facing the prevailing wind.
